(19) United States
(12) Patent Application Publication
(10) Pub. No.: US 2026/0011263 A1
(43) Pub. Date: Jan. 8, 2026

(54) SYSTEM AND METHOD FOR DETERMINING A PAGE LOCATION IN A BOOK

(71) Applicant: Hallmark Cards, Incorporated, Kansas City, MO (US)

(72) Inventor: Phu Dang, Shawnee, KS (US)

(21) Appl. No.: 19/262,789

(22) Filed: Jul. 8, 2025

Related U.S. Application Data
(60) Provisional application No. 63/668,595, filed on Jul. 8, 2024.

(51) Int. Cl. G09B 17/00; G01D 5/34; G01J 1/44

(52) U.S. Cl. CPC G09B 17/006; G01D 5/34; G01J 1/44

(57) ABSTRACT

An improvised book is provided and method for electronically determining a page location in the book. The book can include a body, a first page having a first hole that is covered by a first film that limits an amount of light that can pass through the first hole, a second page having a second hole that is aligned with the first hole and that is covered by a second film that limits an amount of light that can pass through the first hole, and an electronic light-reactive (“LR”) sensor disposed below the first and second holes that is useable to facilitate determining whether the book is opened to the first page or second page based on an amount of light reaching the LR sensor.

### CROSS REFERENCE TO RELATED APPLICATIONS

This application claims the benefit of U.S. Provisional Application No. 63/668,595 (filed on Jul. 8, 2024 and entitled SYSTEM AND METHOD FOR DETECTING A LOCATION IN A RECORDABLE STORYBOOK), which is incorporated by reference herein in its entirety for all purposes.

### BACKGROUND

Some books aspire to include multimedia experiences. For example, consider a recordable storybook where a user might be allowed to record a message for each page so that a recipient could hear a playback of the per-page messages. A problem with books that purport to enable that functionality is accurately determining page locations. In the past, books relied on one physical hole per page or one button per page. An eight-page book would require eight holes drilled through various pages. This interferes with the aesthetics of the book and its artwork and limits the number of pages. And associating each page with its own respective button limits the number of pages, complicates recording and playback, and increases cost.

A need exists for page-detection method and system that does not rely on a one-to-one mapping of holes to pages or pages to buttons.

### BRIEF DESCRIPTION OF THE DRAWINGS

FIG. 1 depicts an illustrative electronics architecture of a recordable storybook suitable for practicing an embodiment of the disclosed technology.

FIG. 2A depicts an illustrative book that includes a body suitable for practicing an embodiment of the disclosed technology.

FIG. 2B depicts a simplified version of FIG. 2A that focuses more on the book aspect suitable for practicing an embodiment of the disclosed technology.

FIG. 2C depicts a perspective view of aspects of a book suitable for practicing an embodiment of the disclosed technology.

FIG. 2D depicts a perspective view of a book suitable for practicing an embodiment of the disclosed technology.

FIG. 2E depicts a perspective view of a book with some aspects called out suitable for practicing an embodiment of the disclosed technology.

FIG. 2F depicts a zoomed-in ariel view looking through the hole of pages of a book suitable for practicing an embodiment of the disclosed technology.

FIGS. 3A-3H depict stages of turning the pages of a book and views thereof in accordance with an embodiment of the disclosed technology.

FIG. 4 depicts an illustrative method suitable for practicing an embodiment of the disclosed technology.

### DETAILED DESCRIPTION

The subject matter of the present disclosure is described with specificity herein to meet statutory requirements. The description is not intended to limit the scope of the claimed invention divorced from the claims. Rather, the claimed subject matter might be embodied in other ways and include different steps or combinations of steps similar to the ones described in this document in conjunction with other present or future technologies.

Although the terms “step” and/or “block” are used herein to connote different elements of methods employed, the terms should not be interpreted as implying any particular order among or between various steps unless and except when the order of individual steps is explicitly stated. Each method described herein may comprise a computing or electronic process that may be performed using various combinations of hardware, firmware, or software. Various functions may be carried out by a processor (variously referred to as a microcontroller or controller herein) executing instructions stored in memory. Some methods may also be performed as stored computer-executable instructions are executed.

Aspects of the disclosed technology provide an enhanced book or related to an enhanced method for reading a book. In some embodiments, this is a recordable book that receives or provides audio playback. Sometimes this enhances a user's experience. Other times, it enables it—such as in the case of visually impaired users who would not otherwise be able to read a book or write messages to an intended recipient about content on various pages of a book.

The disclosed technology is not limited to recordable storybooks, but that example is provided to help illustrate aspects of the disclosed technology. In one embodiment, a recordable storybook is provided with pages that are thicker than a mere conventional paper-back book.

One embodiment of the disclosed technology provides a recordable storybook that allows a user to open the book to a certain page and indicate a desire to record a message associated with that specific page. This can occur for as many pages as are in the book.

Later, the book can be gifted or otherwise conveyed to a recipient. The recipient can thumb through the book and hear each respective audio message recorded for each page.

In the past, electronically determining which page a book was opened to was difficult, especially without encumbering the artwork or text on pages or having an unseemly number of holes that pierce through various pages. But the disclosed technology provides an improved storybook that allows a much higher number of pages in the book as well as fewer buttons. For example, in one embodiment, only two buttons are included: one to initiate a recording and one to stop the recording. In still other embodiments, a single button can be used to both start recording (or playback) and to stop a recording (or playback). For example, in some embodiments, a switch is used to indicate whether the book is in record mode or playback mode. In other embodiments, messages are pre-recorded and respective messages are played back based on the corresponding page identified.

One aspect of the disclosed technology leverages film coverings (variously referred to as filters) that cover select holes in a recordable storybook. The holes allow light to pass through to a sensor disposed at the bottom of a hole (or set of holes). The film limits the amount of light reaching the sensor. Former technologies did not utilize film coverings in this way.

Throughout this disclosure, reference is made to holes extending through pages of books in various embodiments. Unless specifically stated, these references should not be regarded as referring to holes extending through any certain number of pages. Similarly, various drawings herein depict holes. That is done for ease of reference and to help explain technical aspects of the invention. The depictions are not intended to convey any certain depths of the holes. Although holes may appear to extend through a certain number of pages in a drawing, or even all the pages, unless specifically stated, no certain number of pages is intended to be implicated. Holes that appear to extend completely through a set of pages do not necessarily do so.

The drawings show holes to meet statutory requirements, not to be limiting in placement and depth. For example, they are included so they can be referenced herein by reference numerals. Although some drawings show holes, those are not required unless specifically stated. Sometimes the holes shown are optional.

At a high level, one aspect of the disclosed technology uses cascading layers of film over per-page holes to alter the amount of light that passes through the holes. Light travels through a set of holes and reaches a light-reactive sensor situated below the holes (e.g., at the bottom of a set of holes). In this way, each of five pages, for example, can be identified using a single column of holes that are aligned with each other instead of five separate columns of holes. In one embodiment, the film might restrict, say, 20% of ambient light from passing through it. Thus, no film would let through 100% of ambient light. One layer would allow through about 80% of light. Two layers about 64%. Three layers about 50%. Four layers about 40%. Five layers about 33%, etc. Other types of film can be used as well, such as film that limits 5%, 10%, 15%, 50%, or some other amount of light.

A light-reactive sensor is used to facilitate responses to the varying light levels. A sensor could be a photoresistor (variously referred to as a light sensor, light-reactive resistor, light-dependent resistor (LDR), etc.). In some embodiments, the resistance of a photoresistor is relatively higher in darker environments and lower in lighter environments. This allows for changes in voltage and current to be sensed, including via a light-detector circuit, aspects of which are described in more detail in U.S. provisional application No. 63/668,595, which is incorporated by reference herein.

In other embodiments, a PCB-based or other ambient light sensor is used. An illustrative type of sensor includes the BH1750 16-bit ambient light sensor from Rohm. It provides 16-bit light measurements in lux, the standard unit for measuring light. It can measure from 0 to 65000+ lux or beyond, such as 100,000 lux. Other sensors can be utilized provided they vary an electrical metric (e.g., resistance, current, voltage) in response to varying levels of light.

The film can take on a variety form factors and types. For example, film similar to tint film that is used to tint automobile or home windows may be used based on desired outcomes.

### Illustrative Story-Book Architecture.

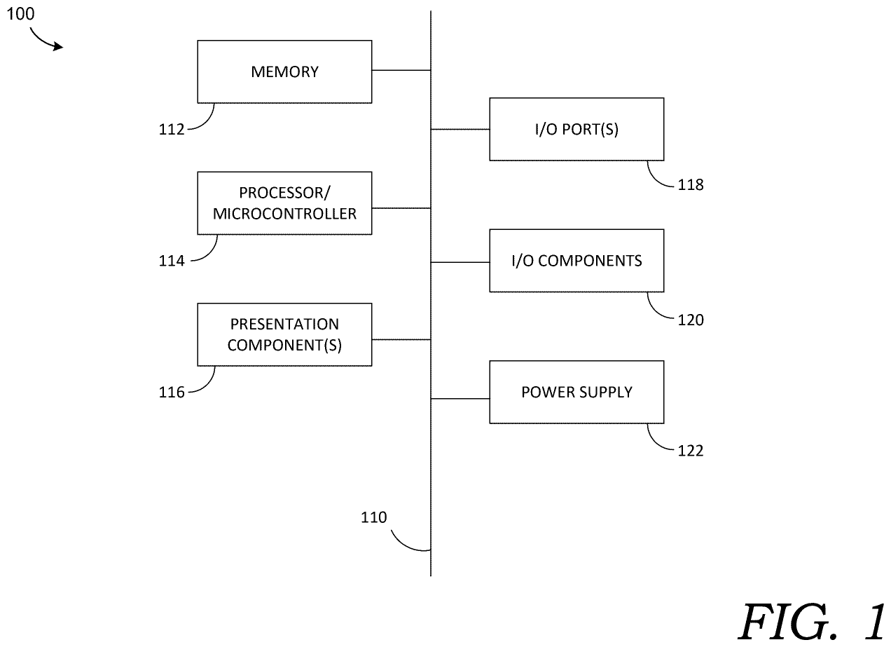

Various types of computing devices can be used in some embodiments to implement desired functionality. FIG. 1 provides a block diagram of structural aspects of such devices. With reference to FIG. 1, a computing device 100 (e.g., recordable story book) includes a bus 110 that directly or indirectly couples the following illustrative devices: memory 112, one or more processors 114 (variously referred to herein as microcontrollers as well), one or more presentation components 116, one or more input/output (I/O) ports 118, one or more I/O components 120 (such as microphones and speakers), and an illustrative power supply 122. Bus 110 represents what may be one or more busses (such as an address bus, data bus, or combination thereof).

Although the various blocks of FIG. 1 are shown with lines for the sake of clarity, these blocks represent logical, not necessarily actual, components. For example, one may consider a presentation component such as a speaker device to be an I/O component. Also, processors have memory. Such is the nature of the art. The diagram of FIG. 1 is merely illustrative of an exemplary computing device that can be used in connection with one or more embodiments of the disclosed technology. (For example, presentation component 116 may be embodied as presentation component 130 and/or may be used as part of a user interface).

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise Computer-storage media and communication media. Computer-storage media includes both volatile and nonvolatile, removable and non-removable media implemented in any method or technology for storage of information such as computer-readable instructions, data structures, program modules or other data.

Computer-storage media includes, but is not limited to, RAM, ROM, EEPROM, flash memory or other memory technology, solid-state storage, or any other medium that can be used to store the desired information and which can be accessed by computing device 100. Computer-storage media does not include signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. The computer-storage media can be non-transitory and embody non-transitory computer-executable instructions. Computing device 100 includes one or more processors/microcontrollers 114 that read data from various entities such as memory 112 or I/O components 120. Presentation component(s) 116 presents data indications to a user or other device. Exemplary presentation components include a display device, speaker, and/or the like.

The I/O ports 118 allow computing device 100 to be logically coupled to other devices or internal I/O components 120, some of which may be built in. Illustrative components include a microphone, etc. The I/O components 120 may provide a natural user interface (NUI) that processes other physiological inputs generated by a user. In some instances, inputs may be transmitted to an appropriate network element for further processing. Additionally, the computing device 100 may be equipped with (or operate in conjunction with) accelerometers or gyroscopes that enable detection of motion. The output of the accelerometers or gyroscopes may be provided to the display of the computing device 100 to render immersive augmented reality or virtual reality.

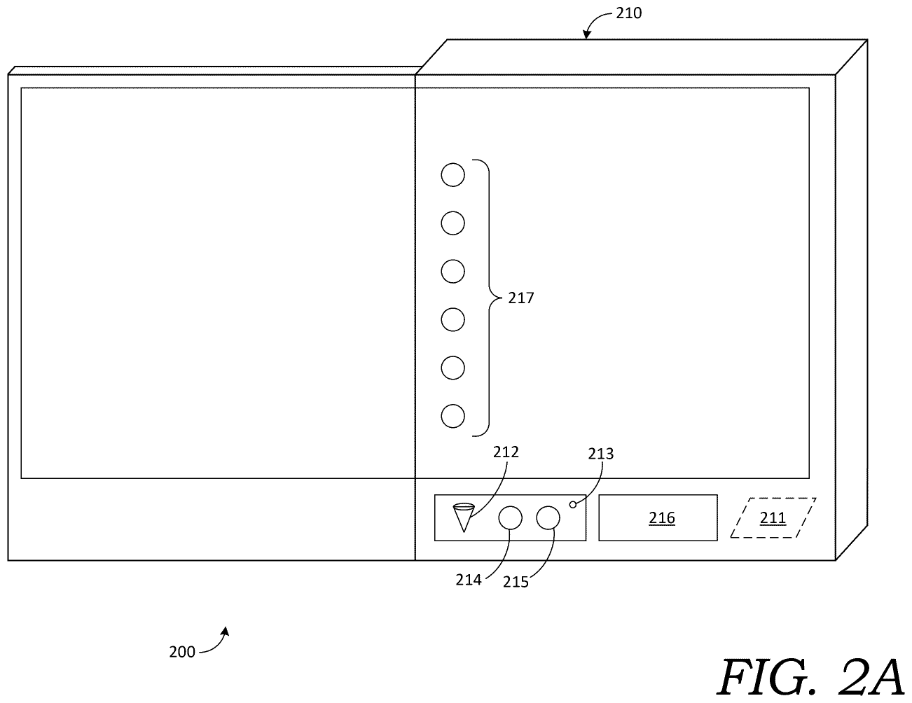

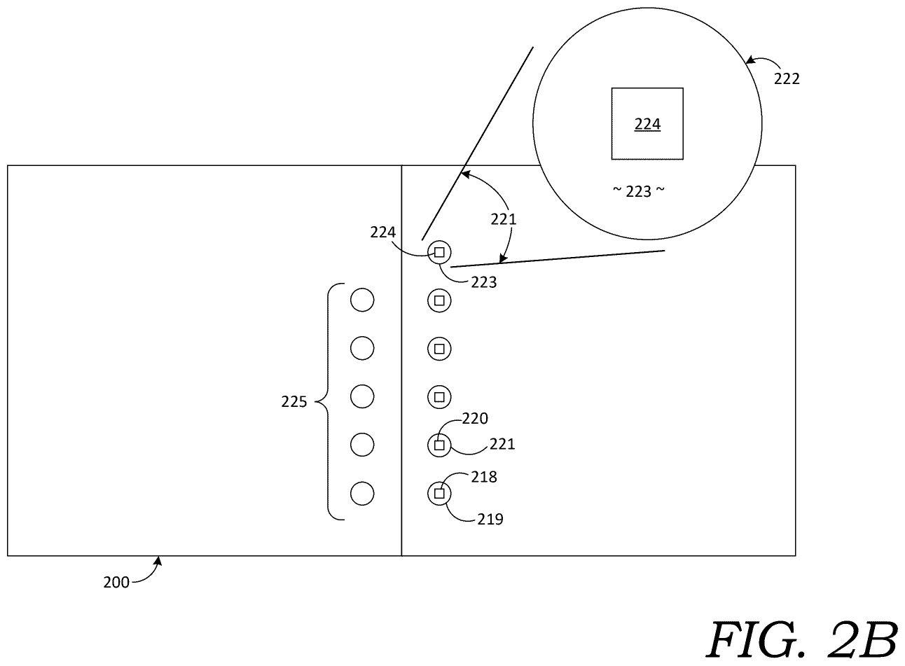

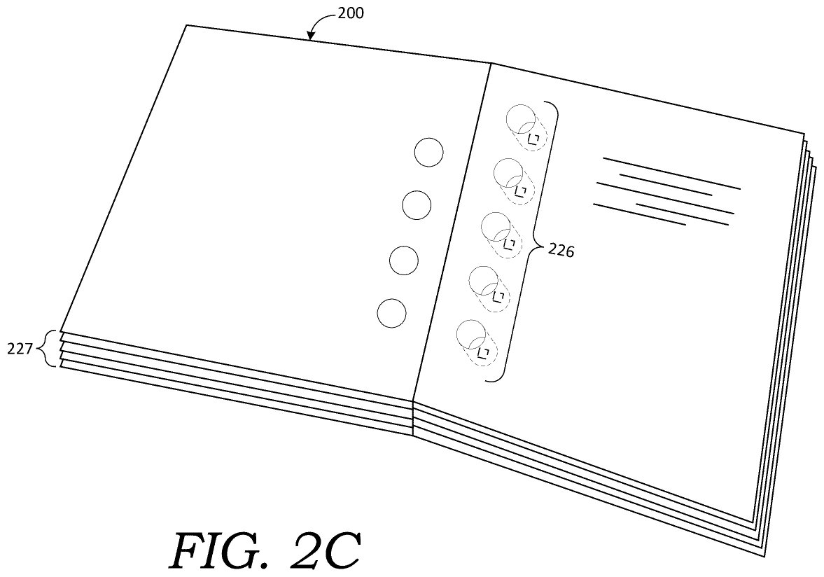

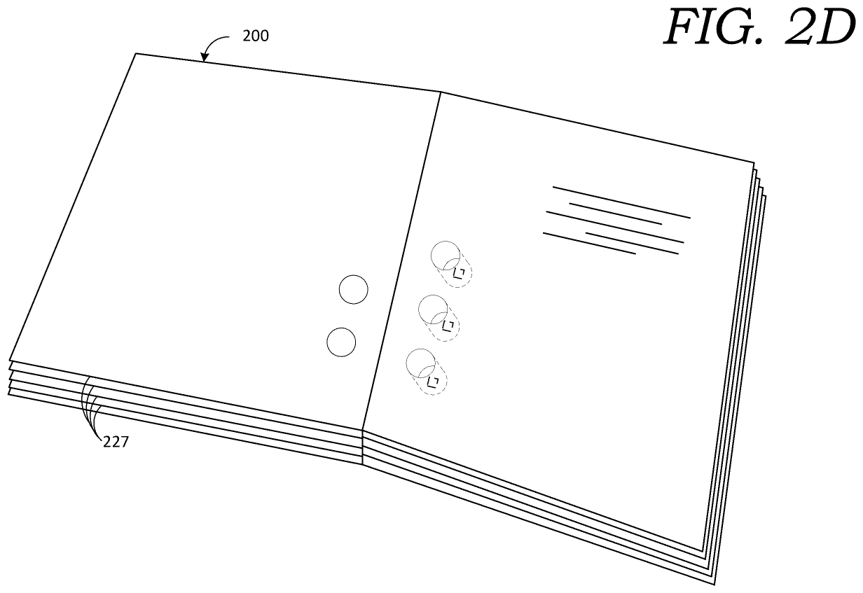

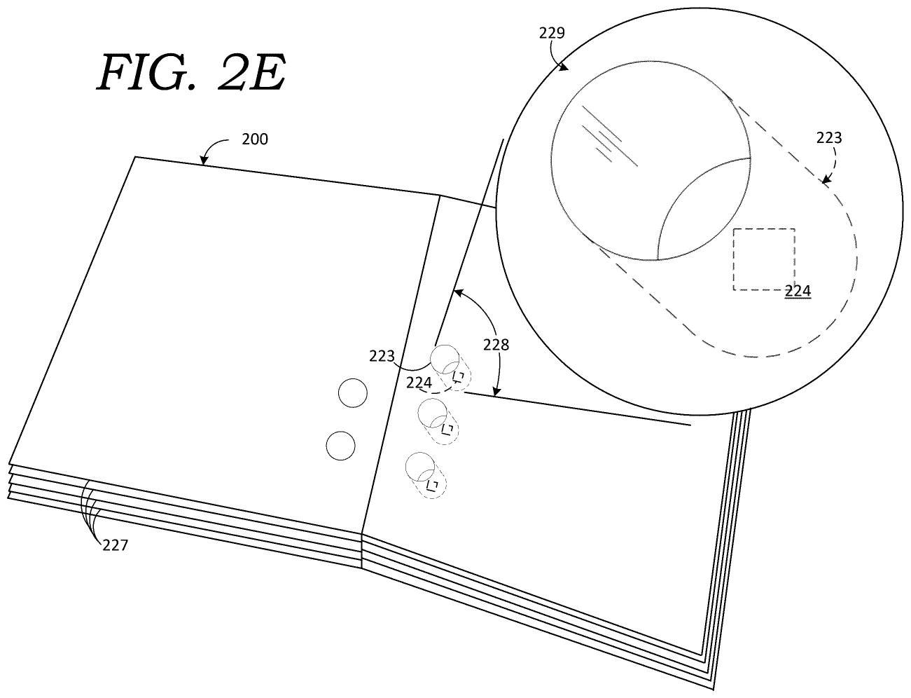

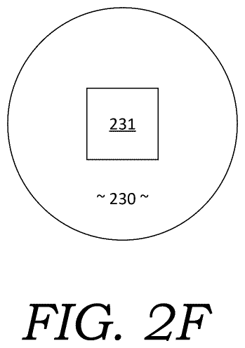

Turning now to FIG. 2, an illustrative book 200 suitable for practicing an embodiment of the disclosed technology is shown. The same numeral 200 will be used to reference books in other figures for simplification. Book 200 includes a body 210. Body 210 can take on a variety of form factors. It is not limited to a rectangular shape as shown. It could be circular, oblong, etc.

In one embodiment, body 200 provides space to include components such as those depicted in FIG. 1. For example, body 200 can house a set of computer-executable instructions 211 that, when executed, perform the various methods disclosed herein. Body 200 can also provide access to a speaker 212, a microphone 213, and one or more recording controls. In one embodiment, a recording control takes the form of a button 214, which can start a recording session. Another button 215 can be used to indicate that recording is to stop. Alternatively, button 214 can be pressed again to stop the recording.

Buttons 214 and 215 can have other functionalities. For example, during playback, button 214 can be used to play a message and button 215 can be used to stop the recording.

In other embodiments, playback occurs automatically as pages are turned. Turning from one page stops the current recording associated with that page from playing. Turning to the next page automatically begins playing the recording associated with the next page.

A power supply 216 provides power. It can be a battery source or similar.

A plurality of holes 217 is shown for illustrative purposes. An aerial view is presented in FIG. 2A. Not all holes need to be present. Some holes extend through one or more pages—a first plurality of pages. Other holes may go through another set of pages. Still other holes may extend through yet another set of pages. Holes 217 allow light to pass through the pages.

FIG. 2B depicts a simplified view of book 200. Small squares inside the holes depict light-reactive (“LR”) sensors (or just “sensors” herein) at the base of each set of holes. For example, sensor 218 is shown below hole 219 (which may be formed by a set of individual holes through various pages). Likewise, sensor 220 is disposed below hole 221. Hole 219 might extend through all pages whereas hole 221 might extend through only some pages, including a different set of pages.

As mentioned, sensor 218 (and all such sensors discussed herein) can be a light-reactive sensor that responds to varying light levels. It could be a photoresistor whose resistance varies with light exposure, a PCB-based ambient light sensor such as the BH1750 16-bit ambient light sensor from Rohm, or other sensor that varies an electrical metric (e.g., resistance, current, voltage) in response to varying levels of light. In one embodiment, the LR sensor have a wide dynamic range between dark and light that further helps a microcontroller (also referred to as a processor) to better detect different light levels resulting from different numbers of light filters (variously referred to herein as films).

Lines 221 show a callout 222, which is a zoomed-in view of hole 223 and sensor 224.

In some embodiments, as pages with holes are turned, they accrue on opposite pages, as reflected by the set of holes 225. Holes such as 225 are an artifact of holes 217 (in FIG. 2A). But processes described herein could be used to identify those pages as well.

FIG. 2C shows another view of the same illustrative book 200. Aspects of FIG. 2C are shown in perspective view. For example, the set of holes 226 is shown as having depth. Each hole includes a corresponding LR sensor at its base, shown in broken lines. The broken lines of the sensor are clearer in the callout of FIG. 2E. Again, the holes of set 226 do not all necessarily start or extend through the same number of pages. In fact, they generally do not. Illustrative pages 227 are also shown.

FIG. 2D shows another view of book 200 with other aspects shown in perspective view. Pages 227 are shown in FIG. 2D as well. As can be seen in FIG. 2D, book 200 may have significant depth.

FIG. 2E shows another view of book 200. Lines 228 direct the viewer to callout 229, which shows a zoomed in view of illustrative hole 223 and its corresponding sensor 224 situated underneath (or at the base of) hole 223.

FIG. 2F is a zoomed-in aerial view of any of the holes mentioned herein. An illustrative sensor 231 is situated at the base of hole 230. Hole 230 is an illustrative example of any of the holes (or set of holes) discussed herein.

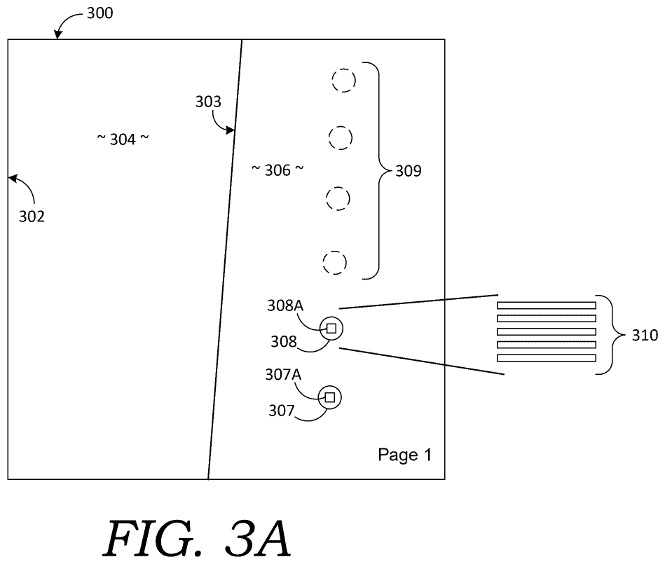

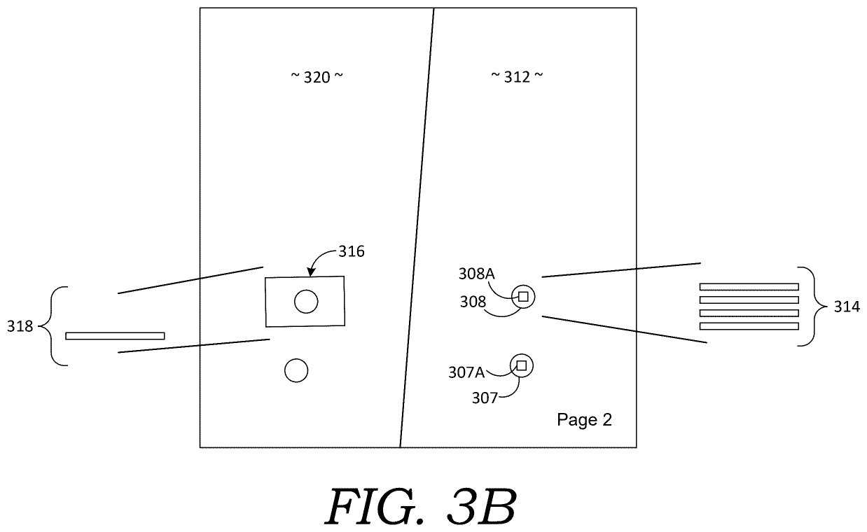

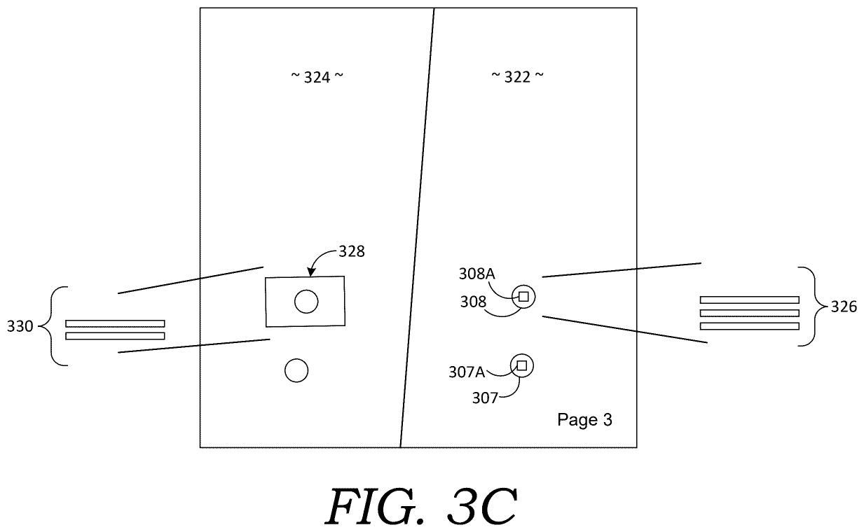

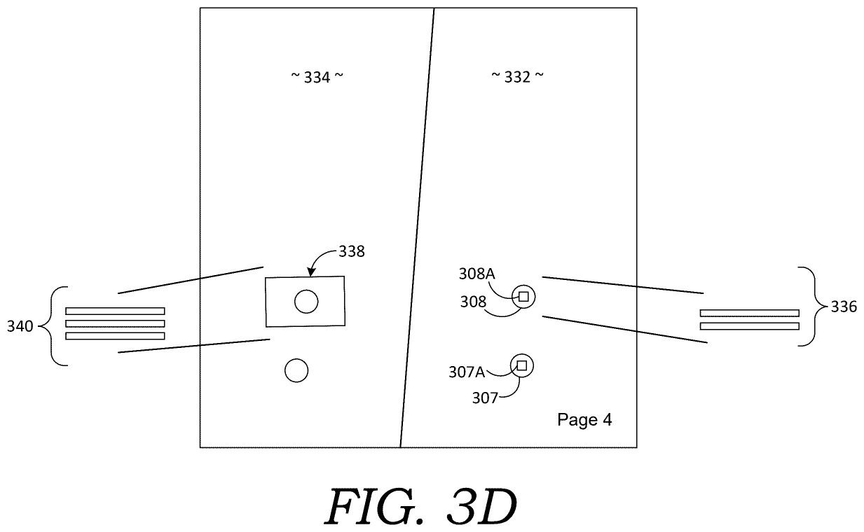

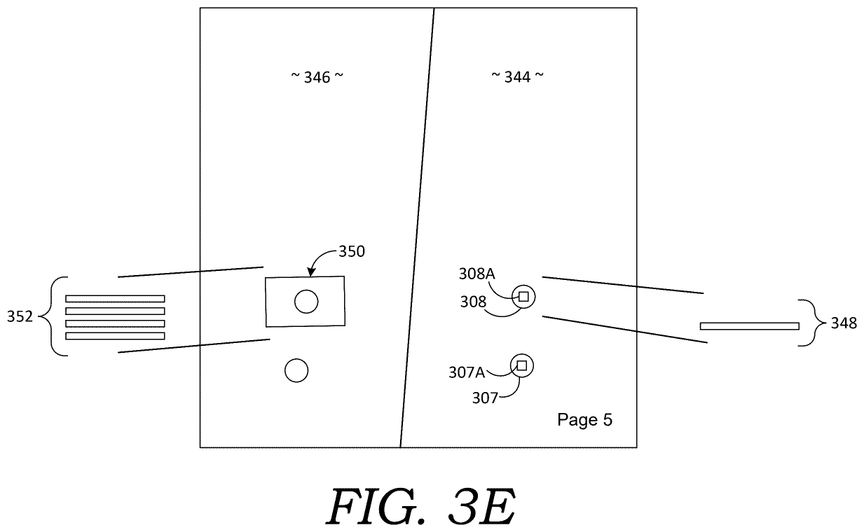

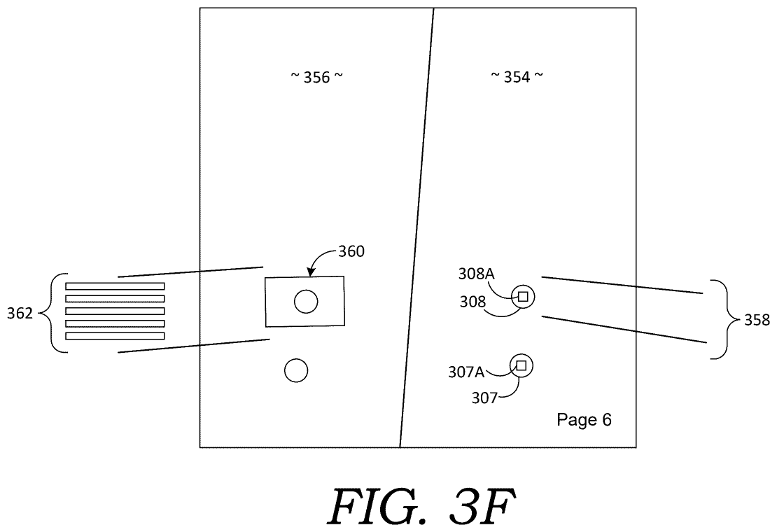

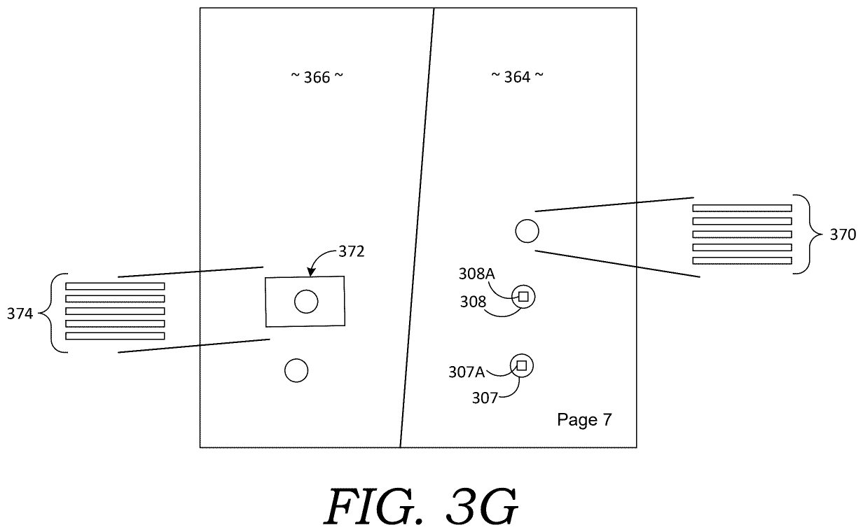

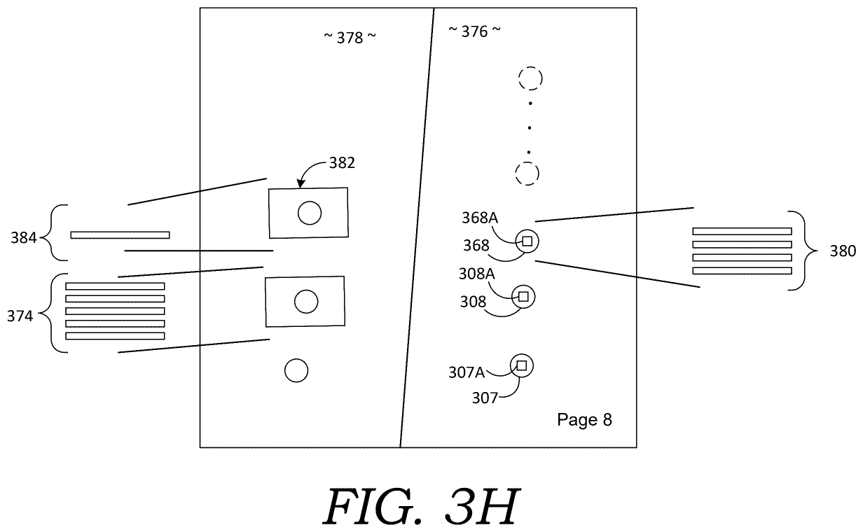

Turning now to FIG. 3A, a partial view of a book 300 (like book 200) is shown. Outline 302 represents a portion of pages. Line 303 represents a page separation, distinguishing left page 304 from right page 306. FIGS. 3A-3H will be referenced to help explain aspects of a page-identification process in accordance with an embodiment of the disclosed technology. For simplicity, not all LR sensors are not shown. But they are present at the base of each hole whose light is to be measured.

In this example, page 306 is shown as “Page 1.” It includes hole 307 and 308 in one embodiment. Other holes 309 are shown in broken lines because they would not be visible from Page 1. The holes can range from about 4-14 mm in various embodiments or be larger or smaller based on applications.

In this embodiment, hole 307 is a reference hole. Its sensor 307A will receive full, unimpeded light because no films cover any constituent hole that makes up hole 307. In this way, sensor 307A can be used to provide a base measured level of light. Varying light levels can then be compared to the base level at sensor 307A to increase the accuracy of a page-detection process. But reference hole 307 is not necessary. Instead, the other sensors can act on their own. They can act based on preidentified expected values in some embodiments. In other embodiments, a switch (not shown) can be used to indicate different base ambient light levels (e.g., daylight, indoor, or dim).

Although it cannot be seen looking down on FIG. 3A, a set 310 of five layers of film is shown. Layers 310 are made up of five coverings of five holes, all aligned below the top hole. Five layers are arbitrarily shown merely for illustrative purposes. More or fewer filters can be used depending on desired outcomes. Film can be applied to the front or back of pages. In this example, film is applied to the backs of pages.

Right-page 306 includes only two holes in this embodiment: a reference hole 307 and hole 308, which is composed of six constituent holes on six different pages. No holes are shown on left-page 304 at this stage because the right pages have not yet been turned. As will be explained, single hole 308 can be used to identify as many pages as varying levels of light detections are desired. For example, assume six pages are desired to be identified per hole. Five pages would have film covering their respective holes. The last page would not have any film.

For example, in FIG. 3A, five pages of holes are each covered by a respective film covering, illustrated by the five film layers 310. Assuming each film layer blocks 10% of the ambient light, light sensor 308A will receive only about 60% of the full ambient light that would otherwise have been received with no filters. This is because the first layer of film would allow about 90% of ambient light through, two layers about 81% (0.9*90%), three layers about 73% (0.9*81%), four layers about 66% (0.9*73%), and five layers about 60% (0.9*66%).

In this example, layers of film are removed in reverse order. Alternatively, layers could be progressively added instead of progressively removed.

Thus, sensor 308 in FIG. 3A would sense about 60% of light it would expect with no film. That would facilitate microcontroller 114 determining that five layers of film are present, indicating that page 306 would be the first page of the book. Programming would make such determination based on five varying light levels (and no other sensors of set 309 receiving any light because they are covered). The system's programming (computer-executable instructions) could have been programmed to detect only two levels of light (e.g., no film and one layer) or three light levels (no film, one layer, and two layers). This is an implementation choice.

Turning page 306 would result in the scenario of FIG. 3B. Now, in FIG. 3B, sensor 308A is overlain by only four layers of film 314 instead of the five indicated by numeral 310 in FIG. 3A. This is because one layer of film 316 (covering the rear of the first uppermost hole 308 on page 306) has been removed. Numeral 318 refers to one layer of film that has accumulated and is visible on new left-page 320.

Thus, the system determines that the opened-to page is Page 2 in FIG. 3B. In one embodiment this occurs because it is programmed to distinguish between five varying levels of light that might reach sensor 308A. Other levels could be used as well. In one embodiment, then system would be programmed to identify Page 1 when sensor 308A receives about 60% ambient light. It would likewise be programmed to identify Page 2 when sensor 308A receives about 65% light. It would be programmed to identify Page 3 when sensor 308A receives about 73% light. It would be programmed to identify Page 4 when sensor 308A receives about 81% light. It would be programmed to identify Page 5 when sensor 308A receives about 90% light. It would be programmed to identify Page 6 when sensor 308A receives about 100% light.

The accuracy of the above determinations can be enhanced by including optional reference sensor 307A that would provide a baseline indication of full ambient light.

If reference hole 307 is not used, then a single hole 308 could be used to identify six different pages whereas prior-art methods would have required six holes or six buttons. Even using refence hole 307 would result in using only two holes to identify six pages instead of six holes.

Turing page 312 of FIG. 3B would reveal new right-page 322 and left page 324 of FIG. 3C. Now, as indicated by numeral 326, only three layers of film are obscuring sensor 308A. This would convey to microcontroller 114 (or other processor or determining component) that it is receiving about 73% of ambient light, translating to an identification of Page 3. Left-page 324 shows an illustrative film 328 covering the hole in page 324 that formerly made up a portion of hole 308 (the holes all being aligned). Film 328, as with all films, could have covered the front of hole 308 instead of the rear. Numeral 320 shows that now two layers of film have accrued on the left set of pages.

Turing page 322 of FIG. 3C would reveal new right-page 322 and left page 324 of FIG. 3C. Now, as indicated by numeral 326, only two layers of film are obscuring sensor 308A. This would convey to microcontroller 114 (or other processor or determining component) that it is receiving about 81% of ambient light, translating to an identification of Page 4. Left-page 334 shows an illustrative film 338 covering the hole in page 324 that formerly made up a portion of hole 308 (the holes all being aligned). Film 338, as with all films, could have covered the front of hole 308 instead of the rear. Numeral 340 shows that now three layers of film have accrued on the left set of pages.

Turing page 332 of FIG. 3D would reveal new right-page 344 and left page 346 of FIG. 3D. Now, as indicated by numeral 348, only one layer of film overlies sensor 308A. This would convey to microcontroller 114 (or other processor or determining component) that it is receiving about 90% of ambient light, translating to an identification of Page 5. Left-page 346 shows an illustrative film 350 covering the hole in page 346 that formerly made up a portion of hole 308 (the holes all being aligned). Film 350, as with all films, could have covered the front of hole 308 instead of the rear. Numeral 352 shows that now four layers of film have accrued on the left set of pages.

Turing page 344 of FIG. 3E would reveal new right-page 354 and left page 356 of FIG. 3F. Now, as indicated by numeral 358, no layers of film overlie sensor 308A. This would convey to microcontroller 114 (or other processor or determining component) that it is receiving about 100% of ambient light (or, if sensor 307A is being used, about the same amount of light it is receiving), translating to an identification of Page 6. Left-page 356 shows an illustrative film 360 covering the hole in page 356 that formerly made up a portion of hole 308 (the holes all being aligned). Film 360, as with all films, could have covered the front of hole 308 instead of the rear. Numeral 362 shows that now five layers of film have accrued on the left set of pages.

Turing page 354 of FIG. 3F would reveal new right-page 364 and left page 366 of FIG. 3G. Now, a new hole 368 and 368A are revealed. They were formerly covered by pages one through seven in one embodiment. Hole 368 was formerly covered by those pages because it was not necessary for page-identification purposes. This would free those pages to have artwork where hole 368 (and other similar holes) would have been, improving the art. The lack of light having formerly reached sensor 368A would have allowed the system's programming to understand that no pages beyond Page 6 were turned to. Now, the presence of at least some light reaching sensor 368A along with full light reaching sensor 307A enables more pages to be identified.

Alternative or additional nomenclature permits what some might call “chapters” to be identified. For example, pages one through six might be a first chapter-those corresponding to a first set of aligned holes extending to a first sensor such as 307A. Pages seven through twelve might make up a second chapter, corresponding to a second set of aligned holes extending to a second sensor such as 368A. Or perhaps the second chapter has only five pages, in which case hole 368 would be composed of only five constituent holes.

Returning to FIG. 3G, as indicated by numeral 370, five layers of film overlie sensor 368A-though, as discussed, this could more or fewer layers. This would convey to microcontroller 114 (or other processor or determining component) that it is receiving about 60% of ambient light, translating to an identification of Page 7 given that sensor 307A is receiving full ambient light. Left-page 366 shows an illustrative film 372 covering the hole in page 366 that formerly made up a portion of hole 308 (the holes all being aligned). Film 372, as with all films, could have covered the front of hole 308 instead of the rear. Numeral 374 shows that now five layers of film have accrued on the left set of pages.

Turing page 364 of FIG. 3G would reveal new right-page 376 and left page 378 of FIG. 3H. Now, as indicated by numeral 380, only four layers of film overlie sensor 368A. This would convey to microcontroller 114 (or other processor or determining component) that it is receiving about 65% of ambient light, translating to an identification of Page 8 (coupled with the reading of light sensor 308A. Left-page 378 shows an illustrative film 382 covering the hole in page 378 that formerly made up a portion of hole 368 (the holes all being aligned in that column of holes). Film 382, as with all films, could have covered the front of hole 368 instead of the rear. Numeral 384 shows that one layer of film has accrued on the left set of pages in addition to the other five 374.

This process can continue as desired. Other holes 386 could be further utilized to identify other sets of pages.

In the example discussed above, six holes can be used to identify thirty six pages instead of only six.

Similar methods of page identification could be used during playback and recording. For example, if a user opens the book to the seventh page and presses record button 214, then the recording would be stored in connection with that page. In playback mode, button 214 becomes a play button. Opening the book to page seven and pressing button 214 would cause microcontroller 114 to identify the recording corresponding to page seven based on the amount of light received at the various sensors.

### Illustrative Embodiment

Thus, as described herein, a book in one embodiment includes a body, a first page having a first hole that is covered by a first film that limits an amount of light that can pass through the first hole; a second page having a second hole that is aligned with the first hole and that is covered by a second film that limits an amount of light that can pass through the first hole; and an electronic light-reactive (“LR”) sensor disposed below the first and second holes that is useable to facilitate determining whether the book is opened to the first page or second page based on an amount of light reaching the LR sensor.

### Another Illustrative Embodiment

In another embodiment, a book includes a body; one or more processors coupled to a microphone and to a recording control that is useable to initiate a recording; a first page that includes a first front surface, a first rear surface, and a first hole that extends through the first page, wherein the first hole is covered by a first film on the first rear surface that is adapted to limit an amount of light that can pass through the first hole; a second page that includes a second front surface, a second rear surface, and a second hole that is aligned with the first hole to extend it through the first and second pages, wherein the second hole is covered by a second film on the second rear surface that is adapted to limit an amount of light that can pass through the second hole; and a first light-reactive (“LR”) sensor coupled to the one or more processors, wherein the first LR sensor is aligned with and disposed below the first and second holes and adapted to respond to varying levels of light such that a first level of light reaching the LR sensor is useable to determine that the book is opened to the first page while a second level of light reaching the LR sensor is usable to determine that the book is opened to the second page.

The LR can be a photoresistor, an ambient light sensor, or similar electrical component. The book can also include a first plurality of additional pages that each includes a hole, thereby resulting in a first plurality of additional holes that are all aligned with each other, wherein each additional hole is covered with respective pieces of film; and a second LR sensor disposed below the first plurality of additional holes.

The recording control can be a first button that, when pressed, initiates a storing process. The storing process can include storing a first recorded message in a memory component coupled to the one or more processors; associating the first recorded message with the first page, the second page, or one of the first plurality of additional pages based on an amount of light that reaches the first LR sensor, the second LR sensor, or a combination thereof.

The book can also include a reference set of holes that extends through all pages of the book that have any holes and a reference LR sensor disposed beneath the reference set of holes, whereby the reference LR sensor is useable to determine a reference amount of ambient light that the first or second LR sensors should expect to receive.

### Another Illustrative Embodiment

In accordance with an embodiment of the disclosed technology, a book includes a body; a first plurality of pages, wherein each page of the first plurality of pages includes a hole and a piece of film covering the hole, thereby resulting in a first plurality of holes that are aligned with each other, wherein each piece of film limits an amount of light that can pass through the first plurality of holes; and a first electronic light-reactive (“LR”) sensor disposed below the first plurality of holes.

The film can cover a front or a back of each hole.

The body can include one or more non-transitory computer-storage media having computer-executable instructions embodied thereon that, when executed, cause a method of determining which of the first plurality of pages the book is opened to. The method can include receiving an indication of a first amount of light reaching the LR sensor; and based on the first amount of light reaching the LR sensor, identifying a specific page among the first plurality of pages.

Identifying the specific page can include utilizing a circuit that measures a variance of a circuit metric to identify the specific page. The circuit metric can be a current level, a voltage level, a resistance level, an impedance level, a reactance level, or combinations thereof.

The circuit can be a comparator circuit. In one embodiment, the circuit can be or include a Wheatstone bridge.

A reference set of holes can be included that extends through all pages of the book that have any holes, wherein the reference set of holes do not include any film, and a reference LR sensor disposed beneath the reference set of holes. In this way, the reference LR sensor is useable to determine a reference amount of light corresponding to unimpeded ambient light that should reach the reference LR sensor.

An embodiment of a method implemented by the computer-executable instructions can include comparing the first amount of light with the reference amount of light when identifying the specific page among the first plurality of pages.

The book can also include a second plurality of pages, where each page of the second plurality of pages includes a hole and a piece of film covering the hole, thereby resulting in a second plurality of holes that are aligned with each other, wherein each piece of film limits an amount of light that can pass through the second plurality of holes; and a second electronic light-reactive (“LR”) sensor disposed below the second plurality of holes, thereby enabling an identification of any page among the first plurality of pages or the second plurality of pages based on an amount of light received at the first or second LR sensor or combination thereof.

### Reiterated Illustrative Method.

Various methods for determining a page location in book have been described above. This section of the disclosure reiterates aspects of those methods. As explained, one method includes receiving from a light-reactive (“LR”) sensor a first indication of a first amount of light passing through a hole that extends through a first plurality of pages, wherein each page of the first plurality of pages includes a hole that is covered by a film; and determining that the book is opened to a specific page among the first plurality of pages based on a first amount of light reaching the LR sensor.

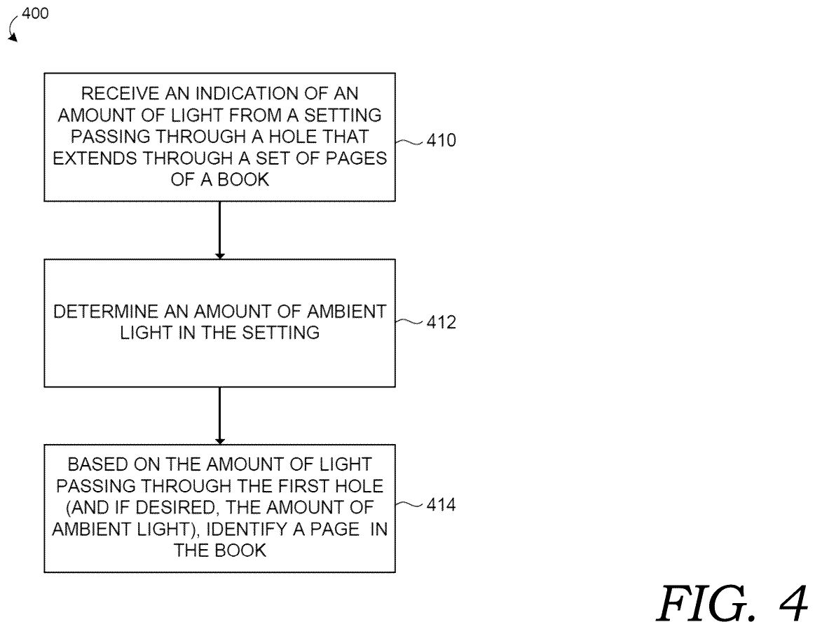

Turning now to FIG. 4, an illustrative method suitable for practicing an embodiment of the disclosed technology is provided and referenced generally by the numeral 400. Step 410 includes receiving an indication of an amount of light from a setting passing through a hole that extends through a set of pages of a book. With reference to FIGS. 1 and 3A, this step could include microcontroller 114 receiving an indication of an amount of light as observed at sensor 308A, which extends through certain pages of book 300. The amount of light can be determined based on a circuit metric of a circuit coupled to or that includes microcontroller 114. For example, the more light that reaches sensor 308A, the less resistance is present. Thus, using Ohms law, a varying level of resistance, current, or voltage is observed and processed by microcontroller 114 consistent with is a set of embodied computer-executable instructions 211 (FIG. 2A).

At an optional step 412, a determination is made as to amount of ambient light that should reach an unimpeded sensor of the book, such as sensor 307A. Unlike sensor 308A that is overlain with five (or however many desired) layers of light-impeding film 314, sensor 307A lies at the bottom of a hole that is not overlain with any layers of film. This can provide an optional base comparison amount-of-light value.

At a step 414, based on the amount of light passing through the first hole (and if desired, the amount of ambient light), a page of the book is identified. This has been explained in detail above. In one embodiment, the microcontroller expects a certain amount of light. That can be hard coded. In another embodiment, a switch indicates varying levels of light, such as daylight, indoors, dim, or dark. In a third embodiment, reference sensor 307A provides a full expected value. Then, if a certain percent of the full expected value of light reaches sensor 308A, that value is mapped to a page. For example, if a film blocks 20% of light, then one layer would be mapped to receiving 80% of the full expected value, two layers about 64% (80% of 80%), three layers about 51% (80% of 64%), and so on. In this way, the amount of light reaching sensor 308A (and other sensors 386 if included) maps to a number layers and holes or sets of holes, which maps to identified page numbers.

### Other Applications.

In another embodiment, a method can be used with an article other than a book, such as with ornaments, tabletop mechanisms, or plush toys. For example, the LR sensor can be disposed within an article oriented toward how a user would view it. The sensor (or another sensor) can be situated behind a dial with a gradient light filter. Rotating the dial changes the amount of light reaching the positional sensor. The microcontroller can determine the position of the dial (and respond accordingly) based on an amount of light reaching the positional sensor. Again, an optional reference sensor can be used to increase the accuracy or position determination where the reference sensor receives full ambient light.

The light sensor could also be used by moving a barrier with holes (and film across the light sensor) by being attached to a moving mechanism (beyond a dial). Varying light levels could be used to activate different audio (like notes on music). The filters could be used as conceptual inserts to block different levels of light, giving it a different experience. A control light sensor and one or more filtered light sensors provides various functional options.

In a plush toy for example, an ambient sensor can be sewn (or otherwise situated) into the body of the plush article, facing a user. An accessory sensor can also be sewn into the plush body, facing the user adjacent to a magnetic mounting point. The plush could have a collection of accessories (e.g. different clothing articles). Each clothing article could have “front” with a filter and associated with a unique light level and a magnetic mounting point. The hat could be secured via the mounting point. The controller would detect the light level and respond accordingly.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub combinations are of utility, may be employed without reference to other features and sub combinations, and are contemplated within the scope of the claims.

What is claimed is:

1. A book, comprising:
a body and a plurality of pages;
one or more processors coupled to a microphone and to a recording control that is useable to initiate a recording;
a first page that includes a first front surface, a first rear surface, and a first hole that extends through the first page, wherein the first hole is covered by a first film on the first rear surface that is adapted to limit an amount of light that can pass through the first hole;
a second page that includes a second front surface, a second rear surface, and a second hole that is aligned with the first hole to extend it through the first and second pages, wherein the second hole is covered by a second film on the second rear surface that is adapted to limit an amount of light that can pass through the second hole; and
a first light-reactive (“LR”) sensor coupled to the one or more processors, wherein the first LR sensor is aligned with and disposed below the first and second holes and adapted to respond to varying levels of light such that a first level of light reaching the LR sensor is useable to determine that the book is opened to the first page while a second level of light reaching the LR sensor is usable to determine that the book is opened to the second page.

2. The book of claim 1, wherein the LR sensor includes one or more of the following:
a photoresistor, or
an ambient light sensor.

3. The book of claim 1, further comprising:
a first plurality of additional pages that each includes a hole, thereby resulting in a first plurality of additional holes that are all aligned with each other, wherein each additional hole is covered with respective pieces of film; and
a second LR sensor disposed below the first plurality of additional holes.

4. The book of claim 3, wherein the recording control includes a first button that, when pressed, initiates a storing process comprising storing a first recorded message in a memory component coupled to the one or more processors.

5. The book of claim 4, wherein the storing process further comprises associating the first recorded message with the first page, the second page, or one of the first plurality of additional pages based on an amount of light that reaches the first LR sensor, the second LR sensor, or a combination thereof.

6. The book of claim 1, further comprising:
a reference set of holes that extends through all pages of the book that have any holes; and
a reference LR sensor disposed beneath the reference set of holes, whereby the reference LR sensor is useable to determine a reference amount of ambient light that the first or second LR sensors should expect to receive.

7. A book, comprising:
a body;
a first plurality of pages, wherein each page of the first plurality of pages includes a hole and a piece of film covering the hole, thereby resulting in a first plurality of holes that are aligned with each other, wherein each piece of film limits an amount of light that can pass through the first plurality of holes; and
a first electronic light-reactive (“LR”) sensor disposed below the first plurality of holes.

8. The book of claim 7, wherein the film covers a front or a back of each hole.

9. The book of claim 8, wherein the body comprises one or more non-transitory computer-storage media having computer-executable instructions embodied thereon that, when executed, cause a method of determining which of the first plurality of pages the book is opened to, the method comprising:
receiving an indication of a first amount of light reaching the LR sensor; and
based on the first amount of light reaching the LR sensor, identifying a specific page among the first plurality of pages.

10. The book of claim 9, wherein identifying the specific page includes utilizing a circuit that measures a variance of a circuit metric to identify the specific page.

11. The book of claim 10, wherein the circuit metric includes one or more of the following:
a current level;
a voltage level; or
a resistance level.

12. The book of claim 10, wherein the circuit includes a Wheatstone bridge.

13. The book of claim 10, further comprising:
a reference set of holes that extends through all pages of the book that have any holes, wherein the reference set of holes do not include any film; and
a reference LR sensor disposed beneath the reference set of holes, whereby the reference LR sensor is useable to determine a reference amount of light corresponding to unimpeded ambient light that should reach the reference LR sensor.

14. The book of claim 13, wherein the method further comprises comparing the first amount of light with the reference amount of light when identifying the specific page among the first plurality of pages.

15. The book of claim 7, wherein each of the first plurality of holes is characterized by one of the following diameters:
about 6 mm;
about 8 mm;
about 10 mm;
about 12 mm; or
about 14 mm.

16. The book of claim 7, wherein the first LR sensor includes one or more of the following:
a photoresistor, or
an ambient light sensor.

17. The book of claim 7, further comprising:
a second plurality of pages, where each page of the second plurality of pages includes a hole and a piece of film covering the hole, thereby resulting in a second plurality of holes that are aligned with each other, wherein each piece of film limits an amount of light that can pass through the second plurality of holes; and
a second electronic light-reactive (“LR”) sensor disposed below the second plurality of holes, thereby enabling an identification of any page among the first plurality of pages or the second plurality of pages based on an amount of light received at the first or second LR sensor or combination thereof.

18. A method for determining a page that a book is opened to, the method comprising:
receiving from a first light-reactive (“LR”) sensor a first indication of a first amount of light passing through a hole that extends through a first plurality of pages, wherein each page of the first plurality of pages includes a hole that is covered by a film; and
determining that the book is opened to a specific page among the first plurality of pages based on a first amount of light reaching the first LR sensor.

19. The method of claim 18, wherein determining that the book is opened to a specific page includes comparing the first amount of light to a base level amount of light that is associated with an unencumbered source of ambient light.

20. The method of claim 19, wherein the base level amount of light is determined by a second LR sensor disposed below a column of holes that extends through a set of pages of the book, wherein the column of holes includes no filters overlying the second LR sensor.
